(19) United States
(12) Patent Application Publication
(10) Pub. No.: US 2025/0313143 A1
(43) Pub. Date: Oct. 9, 2025

(54) Overland trailer

(71) Applicant: ADDAX Overland, LLC, Millcreek, UT (US)

(72) Inventor: Robert Jones, Grantsville, UT (US)

(73) Assignee: ADDAX Overland, LLC, Millcreek, UT (US)

(21) Appl. No.: 18/445,815

(22) Filed: Feb. 16, 2024

Related U.S. Application Data
(60) Provisional application No. 63/475,351, filed on Feb. 16, 2023.

(51) Int. Cl. B60P 3/34; B62D 61/02

(52) U.S. Cl. CPC B60P 3/34; B62D 61/02

(57) ABSTRACT

An overland trailer is disclosed. In various embodiments, the overland trailer includes a base frame, a trailer body mounted atop the base frame, and a tent assembly mounted atop the trailer body.

### CROSS-REFERENCE TO RELATED APPLICATIONS

This application claims the benefit of priority under 35 U.S.C. § 119 to U.S. Provisional Patent Application Ser. No. 63/475,351, entitled “Overland Trailer,” filed on Feb. 16, 2023, which incorporated herein in its entirety for all purposes.

### FIELD

The present disclosure relates generally to trailers and, more particularly, to off-road or overland trailers.

### BACKGROUND

Outdoor enthusiasts frequently use all-terrain or other off-road vehicles (e.g., four-wheel drive vehicles) to travel into areas not otherwise accessible by recreational vehicles or more conventional camping vehicles intended primarily for highway use. Problems and difficulties may be encountered when employing such conventional camping vehicles, stemming largely from the fact such vehicles are not suited for travel over rough terrain. A long-standing need exists to provide a simple, convenient and rugged means for venturing or camping in areas not typically accessible by more conventional camping vehicles.

### SUMMARY

An overland trailer is disclosed. In various embodiments, the overland trailer includes a base frame; a trailer body mounted atop the base frame; and a tent assembly mounted atop the trailer body. In various embodiments, the base frame comprises a top plate having a first longitudinal wall disposed on a first side of the top plate. In various embodiments, the base frame comprises a second longitudinal wall disposed on a second side of the top plate. In various embodiments, the top plate, the first longitudinal wall and the second longitudinal wall are constructed using a single piece of metal.

In various embodiments, the base frame further comprises a first lip member extending along and connected to the first longitudinal wall. In various embodiments, the base frame further comprises a second lip member extending along and connected to the second longitudinal wall. In various embodiments, the top plate, the first longitudinal wall, the second longitudinal wall, the first lip member and the second lip member are constructed using a single piece of metal.

In various embodiments, a longitudinal channel extends along a length of the base frame from a first end of the base frame to a second end of the base frame. In various embodiments, a first transverse wall is disposed at the first end of the base frame. In various embodiments, a second transverse wall disposed at the second end of the base frame. In various embodiments, the overland trailer further includes a tongue member removably received in the longitudinal channel.

An overland trailer is disclosed. In various embodiments, the overland trailer includes a base frame, the base frame including: a top plate having a first longitudinal wall disposed on a first side of the top plate and a second longitudinal wall disposed on a second side of the top plate; a first lip member extending along and connected to the first longitudinal wall and a second lip member extending along and connected to the second longitudinal wall; a longitudinal channel extending along a length of the base frame from a first end of the base frame to a second end of the base frame; and a tongue member removably received in the longitudinal channel. In various embodiments, the first longitudinal wall, the second longitudinal wall, the first lip member and the second lip member are constructed using a single piece of metal. In various embodiments, a first transverse wall is disposed at the first end of the base frame. In various embodiments, a second transverse wall is disposed at the second end of the base frame. In various embodiments, a trailer body is mounted atop the base frame. In various embodiments, a tent assembly is mounted atop the trailer body.

In various embodiments, a structural member extends transversely along a width of and connected to the base frame. In various embodiments, a first end of the structural member is connected to the first lip member and a second end of the transverse member is connected to the second lip member. In various embodiments, the first end of the structural member is configured to receive a first axle assembly and the second end of the structural member is configured to receive a second axle assembly.

The foregoing features and elements may be combined in various combinations, without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 is a perspective view of an overland trailer being towed by an off-road vehicle over rough terrain, in accordance with various embodiments;

FIG. 2A is a perspective view of an overland trailer, with the tent assembly removed, in accordance with various embodiments;

FIG. 2B is a perspective view of an overland trailer, with the tent assembly removed, in accordance with various embodiments;

FIG. 2C is a front view of an overland trailer, with the tent assembly removed, in accordance with various embodiments;

FIG. 2D is a rear view of an overland trailer, with the tent assembly removed, in accordance with various embodiments;

FIG. 2E is a top view of an overland trailer, with the tent assembly removed, in accordance with various embodiments;

FIG. 2F is a bottom view of an overland trailer, with the tent assembly removed, in accordance with various embodiments;

FIG. 2G is a right-side view of an overland trailer, with the tent assembly removed, in accordance with various embodiments;

FIG. 2H is a left-side view of an overland trailer, with the tent assembly removed, in accordance with various embodiments;

FIG. 2I is a perspective view of an overland trailer, with the tent assembly removed, in accordance with various embodiments;

FIG. 2J is a perspective view of an overland trailer, with the tent assembly removed, in accordance with various embodiments;

FIG. 3A is a perspective view of an overland trailer, with the tent assembly and the trailer body removed, in accordance with various embodiments;

FIG. 3B is a perspective view of an overland trailer, with the tent assembly and the trailer body removed, in accordance with various embodiments;

FIG. 3C is a perspective view of an overland trailer, with the tent assembly and the trailer body removed, in accordance with various embodiments;

FIG. 3D is a perspective view of an overland trailer, with the tent assembly and the trailer body removed, in accordance with various embodiments;

FIG. 3E is a perspective view of an overland trailer, with the tent assembly and the trailer body removed, in accordance with various embodiments;

FIG. 4A is a perspective and exploded view of an overland trailer, with the tent assembly and the trailer body removed, in accordance with various embodiments;

FIG. 4B is a perspective and exploded view of an overland trailer, with the tent assembly and the trailer body removed, in accordance with various embodiments;

FIG. 5A is a top view of an overland trailer, with the tent assembly and the trailer body removed, in accordance with various embodiments;

FIG. 5B is a cutaway view of an overland trailer, with the tent assembly and the trailer body removed, taken along the line 5B-5B as illustrated in FIG. 5A, in accordance with various embodiments;

FIG. 5C is a cutaway view of an overland trailer, with the tent assembly and the trailer body removed, taken along the line 5C-5C as illustrated in FIG. 5A, in accordance with various embodiments;

FIG. 5D is a perspective cutaway view of an overland trailer, with the tent assembly and the trailer body removed, taken along the line 5C-5C as illustrated in FIG. 5A, in accordance with various embodiments; and

FIG. 5E is a perspective cutaway view of an overland trailer, with the tent assembly and the trailer body removed, taken along the line 5B-5B as illustrated in FIG. 5A, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an” or “the” may include one or more than one and that reference to an item in the singular may also include the item in the plural. Further, all ranges may include upper and lower values and all ranges and ratio limits disclosed herein may be combined.

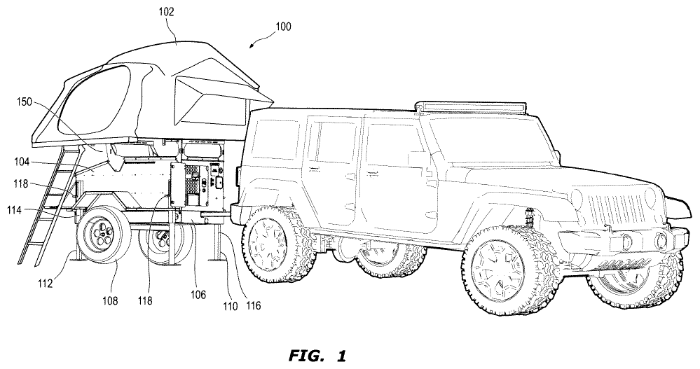

Referring now to the drawings, FIG. 1 schematically illustrates an overland trailer 100 being connected to an off-road vehicle, in accordance with various embodiments. The overland trailer 100 is illustrated in a deployed position and includes a tent assembly 102 positioned atop and connected to a trailer body 104 via a support structure 150. The trailer body 104 is positioned atop and connected to a base frame 106 and a pair of wheels 108 is connected to the base frame 106. In various embodiments, the overland trailer 100 includes a plurality of corner jacks, including a pair of front corner jacks 110 and a pair of rear corner jacks 112. In various embodiments, each of the plurality of corner jacks includes a frame member 114 fixedly connected to the trailer body 104. A support leg 116 is slidably received within the frame member 114 when in an undeployed position and, as illustrated, slidably extended from the frame member 114 when in the deployed position. In various embodiments, a crank system 118 may be used to receive or extend the support leg 116 into or outside of the frame member 114.

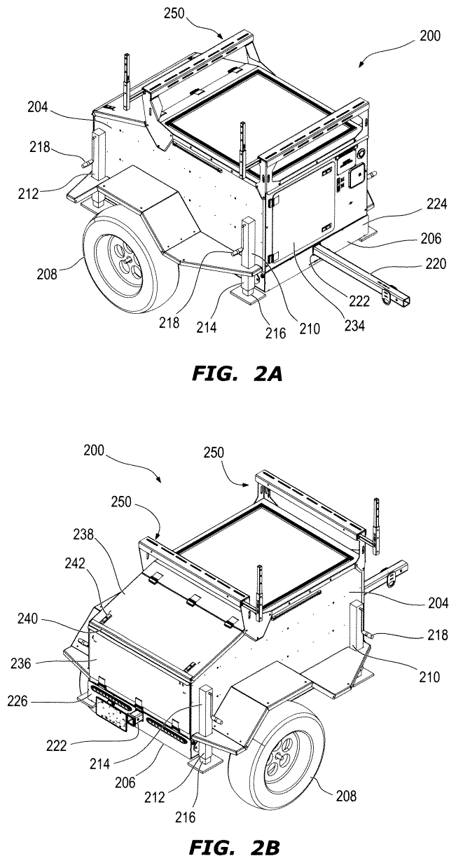

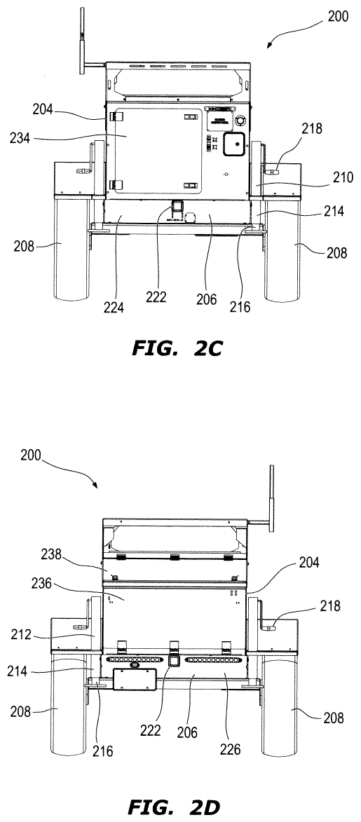

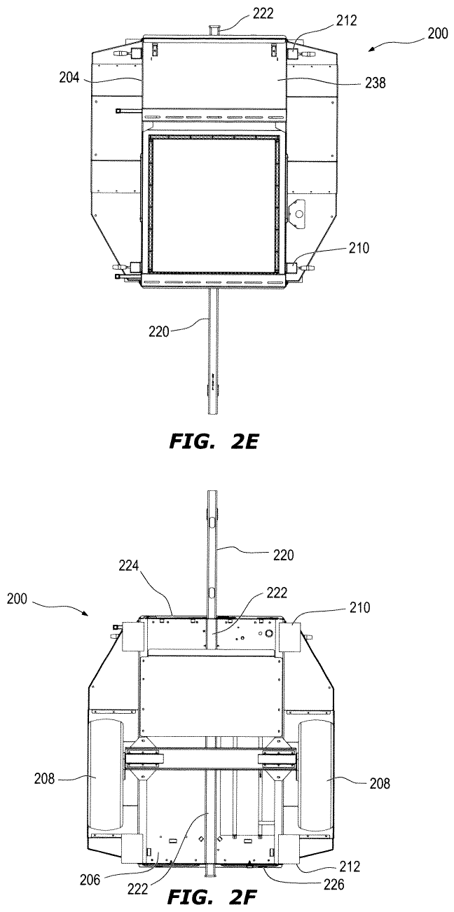

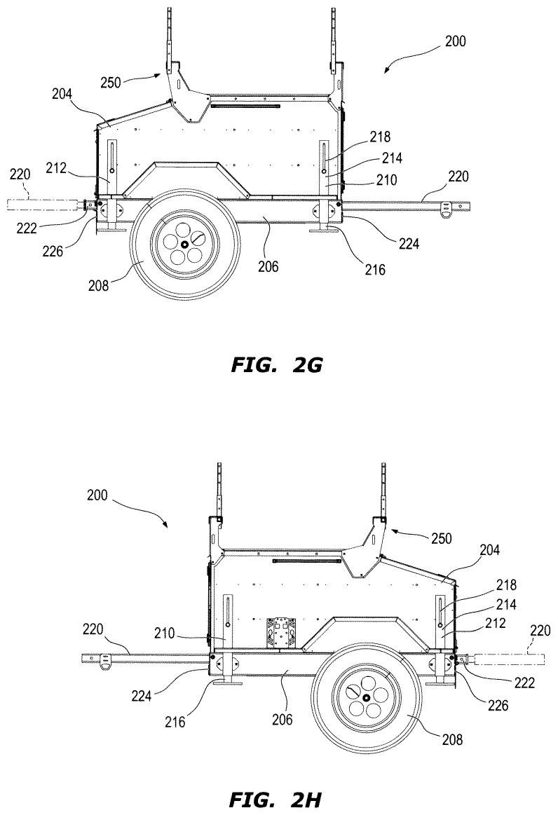

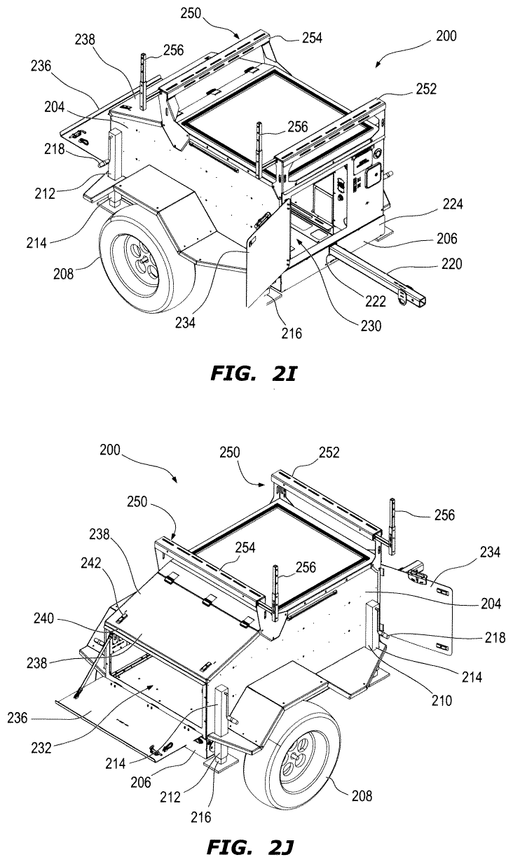

Referring now to FIGS. 2A, 2B, 2C, 2D, 2E, 2F, 2G, 2H, 2I and 2J, an overland trailer 200, similar to the overland trailer 100 depicted in FIG. 1, is illustrated. In various embodiments, the overland trailer 200 (illustrated without a tent assembly) includes a trailer body 204 positioned atop and connected to a base frame 206 and a pair of wheels 208 connected to the base frame 206. In various embodiments, the overland trailer 200 includes a plurality of corner jacks, including a pair of front corner jacks 210 and a pair of rear corner jacks 212 (the corner jacks being depicted in a retracted position). In various embodiments, each of the plurality of corner jacks includes a frame member 214 fixedly connected to the trailer body 204. A support leg 216 is slidably received within the frame member 214 when in an undeployed or a retracted position and slidably extended from the frame member 214 when in the deployed position, as illustrated in FIG. 1. In various embodiments, a crank system 218 may be used to receive or extend the support leg 216 into or outside of the frame member 214.

Still referring to FIGS. 2A, 2B, 2C, 2D, 2E, 2F, 2G, 2H, 2I and 2J, the overland trailer 200 includes a tongue member 220 that is removably received in a longitudinal channel 222 that extends from a first end 224 or forward end of the base frame 206 to a second end 226 or rearward end of the base frame 206. In various embodiments, the tongue member 220 may be removed from the longitudinal channel 222 proximate the first end 224 and placed within the longitudinal channel proximate the second end 226 or vice versa (see, e.g., the shaded structure in FIGS. 2G and 2H). This feature of the present invention facilitates movement of the overland trailer 200 in the event it becomes stuck in a position where forward movement is no longer feasible and backing the overland trailer 200 out of the position is likewise not feasible. Also, in various embodiments, the tongue member 220 may be removed from the longitudinal channel 222 when the overland trailer 200 is in a deployed position—e.g., the tent assembly 102 is deployed as depicted in FIG. 1—to prevent a tripping hazard while walking about the overland trailer 200.

Still referring to FIGS. 2A, 2B, 2C, 2D, 2E, 2F, 2G, 2H, 2I and 2J, and, in particular, FIGS. 2I and 2J, in various embodiments, the overland trailer 200 includes compartment space for storage of tools, food, supplies, etc. For example, in various embodiments, a first compartment 230 is located proximate the forward end of the trailer body 204 and a second compartment 232 is located proximate the rearward end of the trailer body 204. The first storage compartment 230 is defined by a space internal to the trailer body 204 that is enclosed by a first door 234, which may be connected to the trailer body 204 by hinges. Similarly, the second storage compartment 232 is defined by a space internal to the trailer body 204 that is enclosed by a second door 236, which may also be connected to the trailer body 204 by hinges. In various embodiments, the second compartment 232 is also enclosed by a third door 238, which may also be connected to the trailer body 204. In various embodiments, the second door 236 and the third door 238, when both are in the closed position, share a common edge 240 (see, e.g., FIG. 2B), with the doors being locked together along the common edge 240 via one or more locking mechanisms 242. This latter feature—i.e., the second door 236 and the third door 238 joining at a common edge—facilitates open access to the second storage compartment 232 without interference of a transverse member extending from one side of the trailer body 204 to the other that otherwise might be required to lock the doors to when the second storage compartment is enclosed by the doors.

Still referring to FIGS. 2A, 2B, 2C, 2D, 2E, 2F, 2G, 2H, 2I and 2J, and with brief reference to FIG. 1, the overland trailer 204 includes a support structure 250 configured to support a tent assembly and connect the tent assembly to the trailer body 204 (e.g., the tent assembly 102 depicted in FIG. 1 is connected to the trailer body 104 by the support structure 150). Referring more particularly to FIGS. 2I and 2J, the support structure includes a first rail member 252 and a second rail member 254, each rail member being connected to the trailer body 204. In various embodiments, the rail members extend transversely from a first side to a second side of the trailer body 204 (as depicted), though the rail members could also extend longitudinally along the trailer body 204. In various embodiments, the support structure 250 includes one or more auxiliary members 256 that extend upwardly and may be used to secure an awning (not illustrated) of the tent assembly to the trailer body 256.

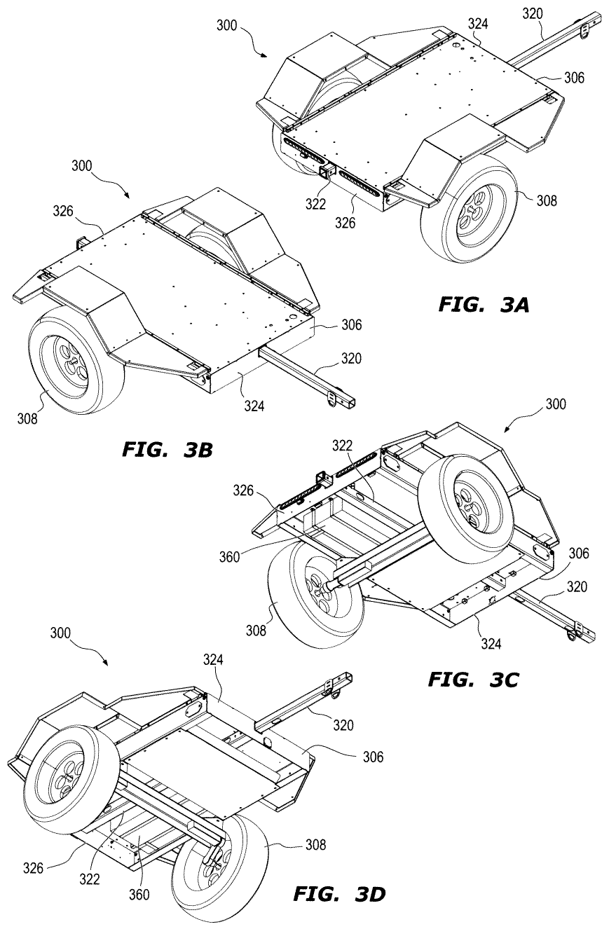

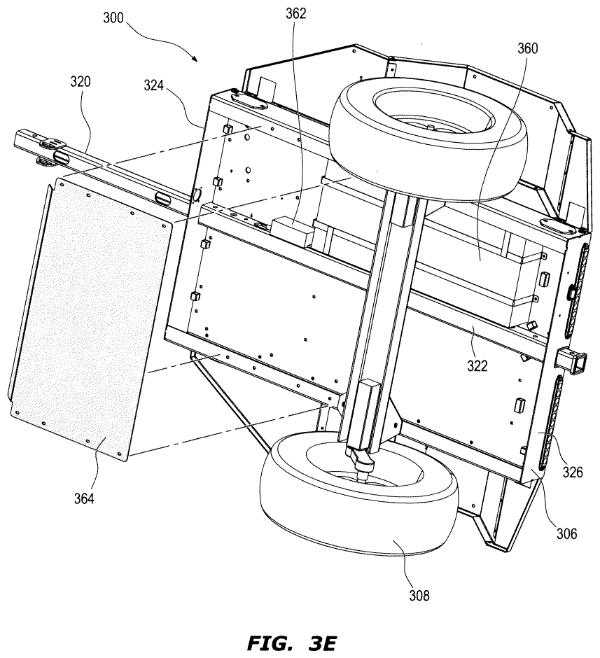

Referring now to FIGS. 3A, 3B, 3C, 3D and 3E, an overland trailer 300 is illustrated with the trailer body and tent assembly removed. The overland trailer 300 includes a base frame 306 and a pair of wheels 308 connected to the base frame 306. The overland trailer 300 includes a tongue member 320 that is removably received in a longitudinal channel 322 that extends from a first end 324 or forward end of the base frame 306 to a second end 326 or rearward end of the base frame 306. In various embodiments, the tongue member 320 may be removed from the longitudinal channel 322 proximate the first end 324 and placed within the longitudinal channel 322 proximate the second end 326 or vice versa. In various embodiments, a water tank 360 is disposed beneath and within and connected to the base frame 306. Similarly, an electrical component box 362 is disposed beneath and within and connected to the base frame 306. In various embodiments, the electrical component box comprises a NEMA box (National Electrical Manufacturers Association) configured for outdoor use. In various embodiments, the electrical component box 362 houses electrical components related to, for example, lighting or battery charging. In various embodiments, a skid plate 364 is connected to the base frame 304 and configured to protect components disposed between the skid plate 364 and the base frame 304, such as, for example, the electrical component box 362.

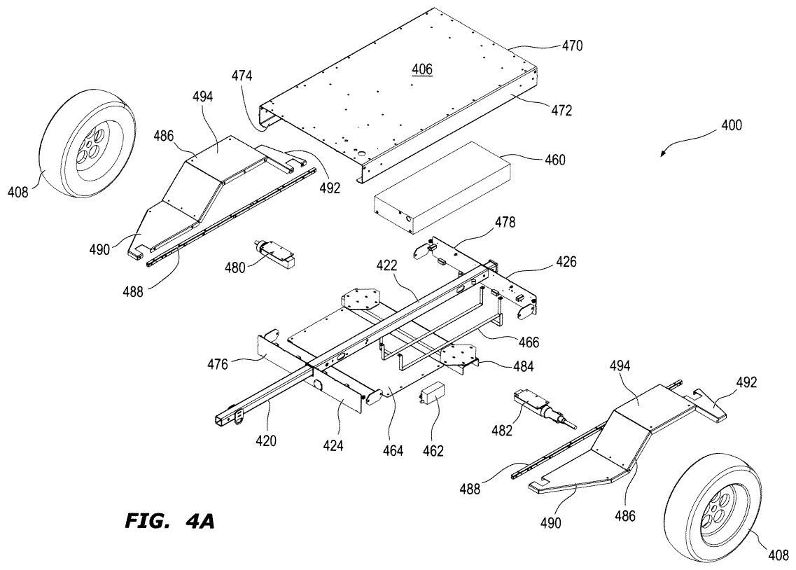

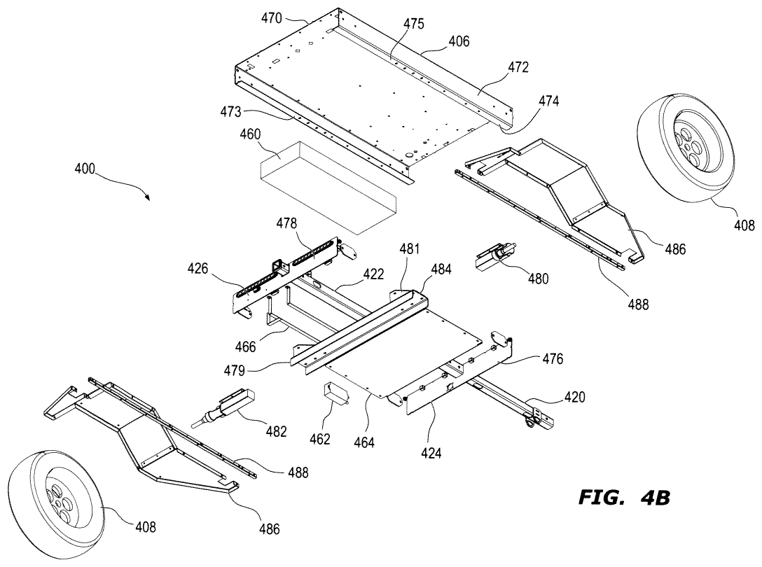

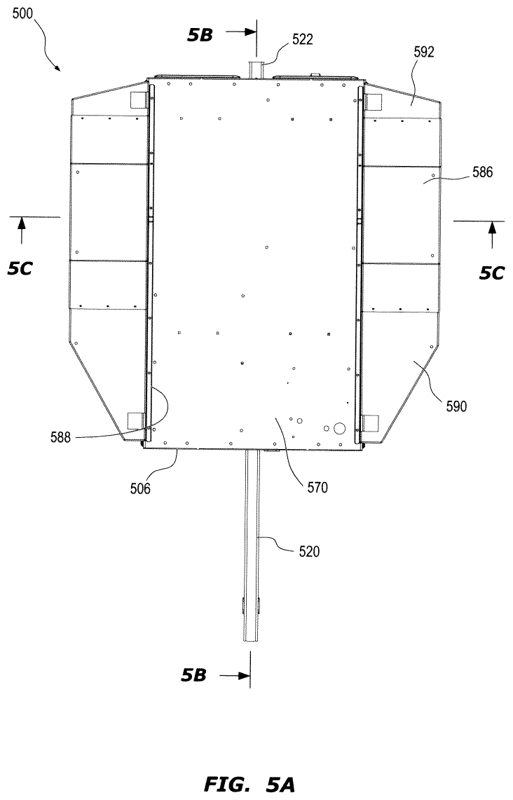

Referring now to FIGS. 4A and 4B, an exploded view of overland trailer 400 is illustrated with the trailer body and tent assembly removed. In various embodiments, the overland trailer 400 includes a base frame 406 and a pair of wheels 408 connected to the base frame 406. As illustrated, in various embodiments, the base frame 406 comprises a main section that includes a top plate 470 having a longitudinal wall 472 disposed on each side of the top plate 470, each longitudinal wall having a lip member 474 that runs the length of the longitudinal wall 472. The base frame 406 further includes a first transverse wall 476 disposed at a first end 424 or forward end of the base frame 406 and a second transverse wall 478 disposed at a second end 426 or rearward end of the base frame 406. Once assembled, and as depicted in various of the drawings (e.g., as depicted in FIG. 3E), the base frame 406 takes the shape of a box-like structure that exhibits a high-degree of strength over and above that of more conventional trailer frames comprising a plurality of longitudinal or transverse rails connected together. In various embodiments, the various components of the base frame 406 may be assembled using bolts or welds or a combination thereof. Further, in various embodiments, the top plate 470 having a longitudinal wall 472 disposed on each side of the top plate 470, may be fabricated of a single piece of metal—e.g., steel—with each longitudinal wall 472 and each lip member 474 being formed by bending the single piece of metal such that a unitary, single-piece construction results. In various embodiments, each component of the base frame is constructed using 3/16-inch (approx. 4.76 mm) steel plate.

Still referring to FIGS. 4A and 4B, the overland trailer 400 includes a tongue member 420 that is removably received in a longitudinal channel 422 that extends from the first end 424 or forward end of the base frame 406 to the second end 426 or rearward end of the base frame 406. In various embodiments, the tongue member 420 may be removed from the longitudinal channel 422 proximate the first end 424 and placed within the longitudinal channel 422 proximate the second end 426 or vice versa. In various embodiments, a water tank 460 is disposed beneath and within and connected to the base frame 406. In various embodiments, the water tank 460 is connected to the base frame 406 by a strap member 466 (or a plurality of such strap members) that is configured for attachment—e.g., via bolts—to the base frame. Similarly, an electrical component box 462 is disposed beneath and within and connected to the base frame 406. In various embodiments, the electrical component box comprises a NEMA box (National Electrical Manufacturers Association) configured for outdoor use. In various embodiments, the electrical component box 462 houses electrical components related to, for example, lighting or battery charging. In various embodiments, a skid plate 464 is connected to the base frame 406—e.g., via bolts—and configured to protect components disposed between the skid plate 464 and the base frame 406, such as, for example, the electrical component box 462.

Still referring to FIGS. 4A and 4B, the overland trailer 400 includes a first axle assembly 480 and a second axle assembly 482 configured to receive the pair of wheels 408. In various embodiments, the overland trailer 400 further includes a structural member 484 that extends transversely along a width of the base frame 406 and that is configured to receive at its ends the first axle assembly 480 and the second axle assembly 482. In various embodiments, a first end 479 of the structural member 480 is configured for connection to a first lip member 473 of the base frame 406 and a second end 481 of the structural member 480 is configured for connection to a second lip member 475 of the base frame 406. When assembled, each of the first axle assembly 480 and the second axle assembly 482, together with the structural member 484, is connected to the base frame 406 via, for example, bolts that extend through the structural member 484. In various embodiments, a fender 486 is connected—e.g., via bolts—to the base frame 406 over each one of the pair of wheels 408. In various embodiments, the fender is constructed using 3/16-inch (approx. 4.76 mm) steel plate, thereby providing sufficient structural strength to enable an individual to stand on the fender 486 to access, for example, a tent assembly (not illustrated) without damaging the fender 486. In various embodiments, a longitudinal rail 488 is configured for connection to the top plate 470 of the base frame 406 proximate each fender 486. The longitudinal rail 488 is configured to connect a front portion 490 and a rear portion 492 of each fender 486 to the top plate 470 of the base frame 406. A center portion 494 of each fender 486 (e.g., the portion of the fender 486 that is disposed over each of the pair of wheels 408) is configured for attachment to a trailer body (e.g., the trailer body 204 illustrated in FIGS. 2I and 2J), providing additional strength for each fender 486.

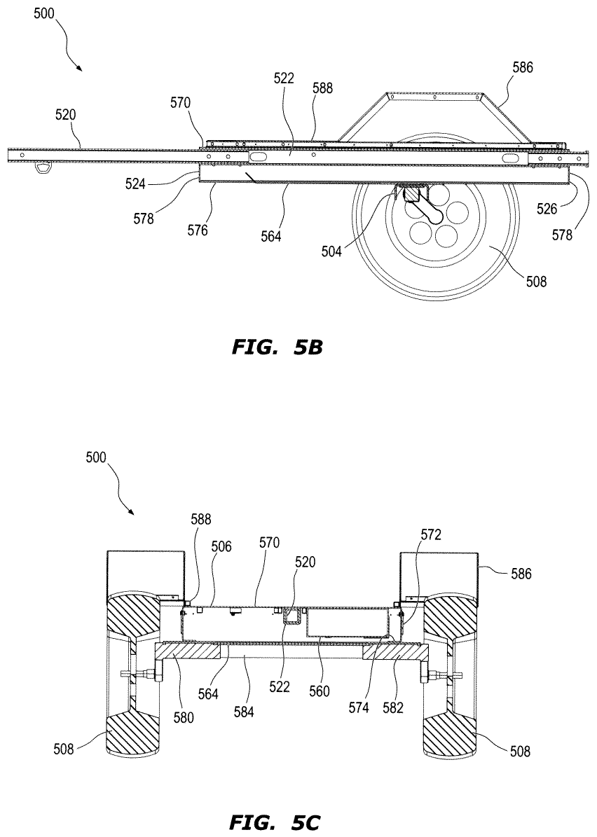

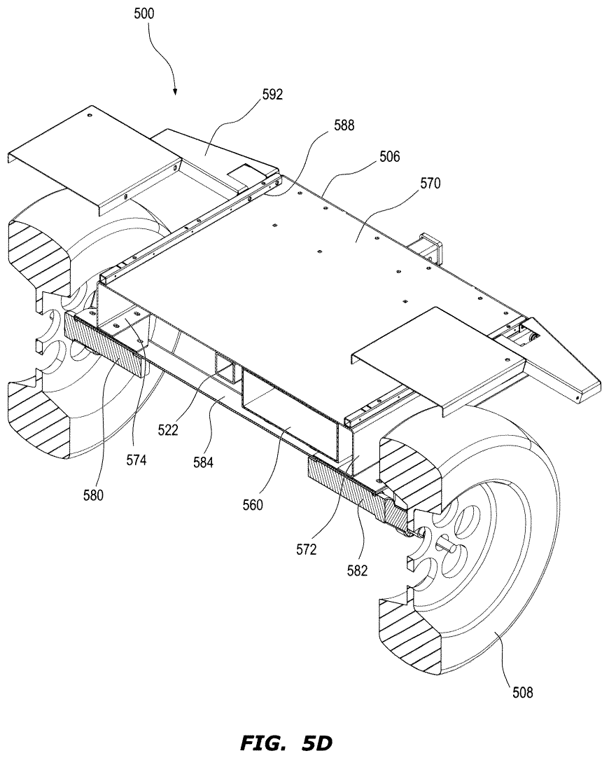

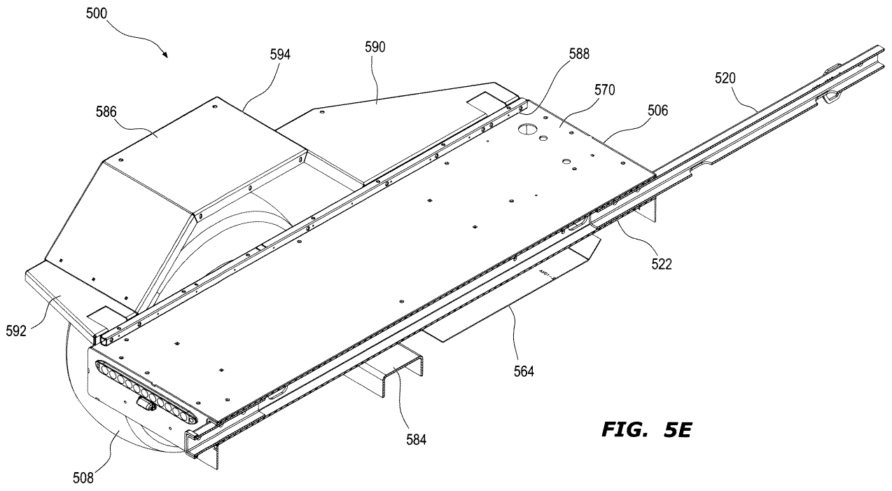

Referring now to FIGS. 5A, 5B, 5C, 5D and 5E, various cross-sectional and perspective views of overland trailer 500, in assembled form, are illustrated with the trailer body and tent assembly removed. Similar to the foregoing description, the overland trailer 500 includes a base frame 506 and a pair of wheels 508 connected to the base frame 506. As illustrated, in various embodiments, the base frame 506 comprises a main section that includes a top plate 570 having a longitudinal wall 572 disposed on each side of the top plate 570, each longitudinal wall having a lip member 574 that runs the length of the longitudinal wall 572. The base frame 506 further includes a first transverse wall 576 disposed at a first end 524 or forward end of the base frame 506 and a second transverse wall 578 disposed at a second end 526 or rearward end of the base frame 506. Once assembled, and as depicted in various of the drawings (e.g., as depicted in FIG. 3E), the base frame 506 takes the shape of a box-like structure that exhibits a high-degree of strength over and above that of more conventional trailer frames comprising a plurality of longitudinal or transverse rails connected together. In various embodiments, the various components of the base frame 506 may be assembled using bolts or welds or a combination thereof. Further, in various embodiments, the top plate 570 having a longitudinal wall 572 disposed on each side of the top plate 570, may be fabricated of a single piece of metal—e.g., steel—with each longitudinal wall 572 and each lip member 574 being formed by bending the single piece of metal such that a unitary, single-piece construction results. In various embodiments, each component of the base frame is constructed using 3/16-inch (approx. 4.76 mm) steel plate.

Still referring to FIGS. 5A, 5B, 5C, 5D and 5E, the overland trailer 500 includes a tongue member 520 that is removably received in a longitudinal channel 522 that extends from the first end 524 or forward end of the base frame 506 to the second end 526 or rearward end of the base frame 506. In various embodiments, the tongue member 520 may be removed from the longitudinal channel 522 proximate the first end 524 and placed within the longitudinal channel 522 proximate the second end 526 or vice versa. In various embodiments, a water tank 560 is disposed beneath and within and connected to the base frame 506. In various embodiments, a skid plate 564 is connected to the base frame 506—e.g., via bolts—and configured to protect components disposed between the skid plate 564 and the base frame 506, such as, for example, the electrical component box 462 illustrated in FIGS. 4A and 4B.

Still referring to FIGS. 5A, 5B, 5C, 5D and 5E, the overland trailer 500 includes a first axle assembly 580 and a second axle assembly 582 configured to receive the pair of wheels 508. In various embodiments, the overland trailer 500 further includes a structural member 584 that extends transversely along a width of the base frame 506 and that is configured to receive at its ends the first axle assembly 580 and the second axle assembly 582. When assembled, each of the first axle assembly 580 and the second axle assembly 582, together with the structural member 584, is connected to the base frame 506 via, for example, bolts that extend through the structural member 584. In various embodiments, a fender 586 is connected—e.g., via bolts—to the base frame 506 over each one of the pair of wheels 508. In various embodiments, the fender is constructed using 3/16-inch (approx. 4.76 mm) steel plate, thereby providing sufficient structural strength to enable an individual to stand on the fender 586 to access, for example, a tent assembly (not illustrated) without damaging the fender 586. In various embodiments, a longitudinal rail 588 is configured for connection to the top plate 570 of the base frame 506 proximate each fender 586. As illustrated in FIG. 5E, the longitudinal rail 588 is configured to connect a front portion 590 and a rear portion 592 of each fender 586 to the top plate 570 of the base frame 506. As also illustrated in FIG. 5E, a center portion 594 of each fender 586 (e.g., the portion of the fender 586 that is disposed over each of the pair of wheels 508) is configured for attachment to a trailer body (e.g., the trailer body 204 illustrated in FIGS. 2I and 2J), providing additional strength for each fender 586.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above-described concepts can be used alone or in combination with any or all of the other above described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed:

1. An overland trailer, comprising:
a base frame;
a trailer body mounted atop the base frame; and
a tent assembly mounted atop the trailer body.

2. The overland trailer of claim 1, wherein the base frame comprises a top plate having a first longitudinal wall disposed on a first side of the top plate.

3. The overland trailer of claim 2, wherein the base frame comprises a second longitudinal wall disposed on a second side of the top plate.

4. The overland trailer of claim 3, wherein the top plate, the first longitudinal wall and the second longitudinal wall are constructed using a single piece of metal.

5. The overland trailer of claim 4, wherein the base frame further comprises a first lip member extending along and connected to the first longitudinal wall.

6. The overland trailer of claim 5, wherein the base frame further comprises a second lip member extending along and connected to the second longitudinal wall.

7. The overland trailer of claim 6, wherein the top plate, the first longitudinal wall, the second longitudinal wall, the first lip member and the second lip member are constructed using a single piece of metal.

8. The overland trailer of claim 7, further comprising a longitudinal channel extending along a length of the base frame from a first end of the base frame to a second end of the base frame.

9. The overland trailer of claim 8, further comprising a first transverse wall disposed at the first end of the base frame.

10. The overland trailer of claim 9, further comprising a second transverse wall disposed at the second end of the base frame.

11. The overland trailer of claim 10, further comprising a tongue member removably received in the longitudinal channel.

12. An overland trailer, comprising:
a base frame, the base frame including:
a top plate having a first longitudinal wall disposed on a first side of the top plate and a second longitudinal wall disposed on a second side of the top plate;
a first lip member extending along and connected to the first longitudinal wall and a second lip member extending along and connected to the second longitudinal wall;
a longitudinal channel extending along a length of the base frame from a first end of the base frame to a second end of the base frame; and
a tongue member removably received in the longitudinal channel.

13. The overland trailer of claim 12, wherein the top plate, the first longitudinal wall, the second longitudinal wall, the first lip member and the second lip member are constructed using a single piece of metal.

14. The overland trailer of claim 13, further comprising a first transverse wall disposed at the first end of the base frame.

15. The overland trailer of claim 14, further comprising a second transverse wall disposed at the second end of the base frame.

16. The overland trailer of claim 15, further comprising a trailer body mounted atop the base frame.

17. The overland trailer of claim 16, further comprising a tent assembly mounted atop the trailer body.

18. The overland trailer of claim 15, further comprising a structural member extending transversely along a width of and connected to the base frame.

19. The overland trailer of claim 18, wherein a first end of the structural member is connected to the first lip member and a second end of the transverse member is connected to the second lip member.

20. The overland trailer of claim 19, wherein the first end of the structural member is configured to receive a first axle assembly and the second end of the structural member is configured to receive a second axle assembly.
